(19) United States
(12) Patent Application Publication
(10) Pub. No.: US 2020/0177643 A1
(43) Pub. Date: Jun. 4, 2020

(54) SYSTEM AND METHOD FOR ESTABLISHING A COMMUNICATION SESSION

(71) Applicant: Fani Bhushan, New Delhi (IN)

(72) Inventor: Fani Bhushan, New Delhi (IN)

(21) Appl. No.: 16/629,021

(22) PCT Filed: Jul. 6, 2018
(86) PCT No.: PCT/IB2018/055018

§ 371 Date: Jan. 6, 2020

(30) Foreign Application Priority Data
Jul. 7, 2017 (IN) 201711023930

(51) Int. Cl. H04L 29/06; H04M 3/42; H04M 3/56

(52) U.S. Cl. CPC H04L 65/1076; H04L 65/1069; H04M 3/567; H04M 3/42348; H04L 65/1003

(57) ABSTRACT

A system includes a processor to receive a first visual image and a second visual image associated with a first user of the first device and a second user of the second device. A first and a second visual identification parameter associated with the first user and the second user are extracted based on the first visual image and the second visual image. The processor receives a request from the first device for connection establishment with a visually accessible user of a device. The request includes a real time visual identification parameter associated with the user. The processor then identifies the user to be the second user when the real time visual identification parameter matches with the second visual identification parameter. A communication session is then established based on a successful confirmation of the match from the first device.

### TECHNICAL FIELD

The present disclosure relates generally to communication systems and more particularly, relates to a system and method for establishing a communication session between two devices.

### BACKGROUND

With advent of internet, the need for enabling one unique device's reach to millions of other devices, have emerged in various formats. Such achievements involve processes engaging the unique user end devices such as, cell phones, computerized mobile devices, tablets, laptops, desktops and other multimedia smart devices, with server devices and instruction input methods from the user. Such inputs may be in form of key board inputs, electromagnetic input, touch based input, sign-based input of voice or sound-based input, physical movement of device-based input. The key element is the process which is adapted, which enables the user to uniquely identify another device of his choice to interact with, utilizing some kind of username, name of identity key.

One such need from user's perspective is identified, which is user's enablement of interacting with some other device user without necessitating to have any prior information of the other device. For example, often one goes out and sees people around in a train, in the restaurants, in the music theatres, in flights or any other public or private place. Sometimes, there is a need to connect to other people we see around us but the only way we can do that is by knowing their name, contact number, address, email address, username or some lead or by physically approaching the user. As invading privacy of a person nearby is not desirable. In the current scenario, there is no way to connect without revealing your digital identity (contact number or address, email address, username) to the person you can see, at the same time, without knowing the username, address, email Id, contact number of the user.

In current scenario, one needs to build a public profile which contains personal information which gets uploaded on a central server where the data may be stored in columns in which the primary key to the data is either name, username, email address or some other form of personal information. If any user searches or sends the signal to the server to search your name, username, email address or any other personal information; the server searches in the database columns if the requested data exists or not and if it does, the data is responded to the user's display unit in a certain format. It simply means that if you want to connect to someone then you need to reveal your name, contact number, address, email address, username to the other user, which may not be desirable.

### SUMMARY

In an aspect of the present disclosure, a system includes a processor to receive a first visual image and a second visual image associated with a first user of the first device and a second user of the second device. A first and a second visual identification parameter associated with the first user and the second user are extracted based on the first visual image and the second visual image. The processor receives a request from the first device for connection establishment with a visually accessible user of a device. The request includes a real time visual identification parameter associated with the user. The processor then identifies the user to be the second user when the real time visual identification parameter matches with the second visual identification parameter. A communication session is then established based on a successful confirmation of the match from the first device.

In another aspect of the present disclosure, a method for establishing a communication session between a first device and a second device is provided. The method includes receiving at least a first visual image associated with a first user of the first device and a second visual image associated with a second user of the second device. The method extracts and stores, at least one first visual identification parameter associated with the first user based on the first visual image and at least one second visual identification parameter associated with the second user based on the second visual image. The method further receives a request from the first device for connection establishment with a device, the request including at least one real time visual identification parameter associated with a user of the device, the user being visually accessible to the first user. Furthermore, the method identifies the user to be the second user when the at least one real time visual identification parameter received in the request matches with the at least one second visual identification parameter associated with the second user. The method communicates the second visual image associated with the second user to a display associated with the first device. Subsequently, the method receives a confirmation from the first device for a successful match between the user of the device requested and the second user associated with the second device. Thereafter the method establishes a communication session between the first device and the second device based on the confirmation received from the first device.

### BRIEF DESCRIPTION OF THE DRAWINGS

The following drawings are referenced in the detailed description:

FIG. 1 illustrates a block diagram of an exemplary system for establishing a communication session between a first device and a second device, in accordance with an example implementation of the present subject matter; and

FIG. 2 illustrates an exemplary method for establishing a communication session between the first device and a second device, in accordance an example implementation of the present subject matter.

### DETAILED DESCRIPTION

The following detailed description refers to embodiments of the present disclosure, examples of which are illustrated in the accompanying drawings. Wherever possible, the same reference numbers are used throughout the drawings to refer to the same or like parts. The terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

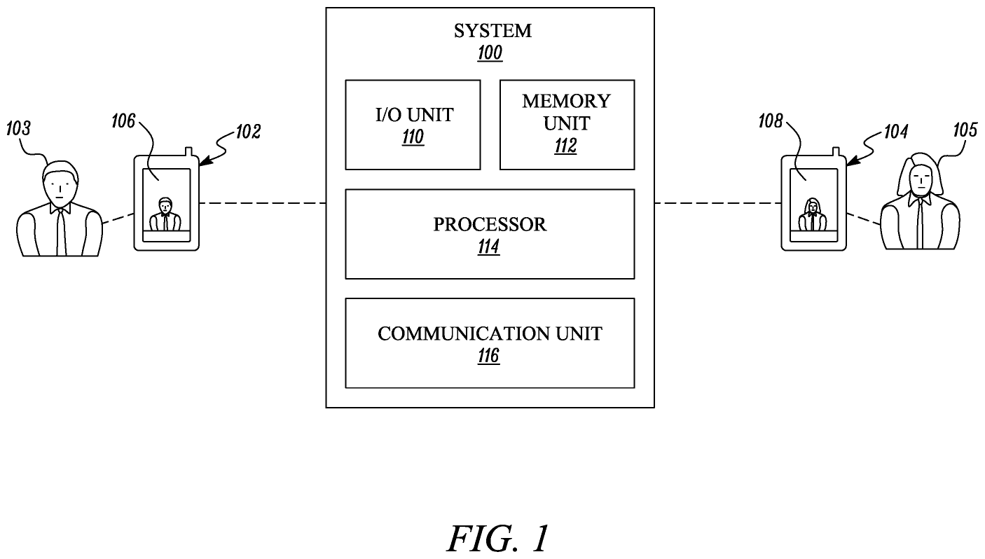

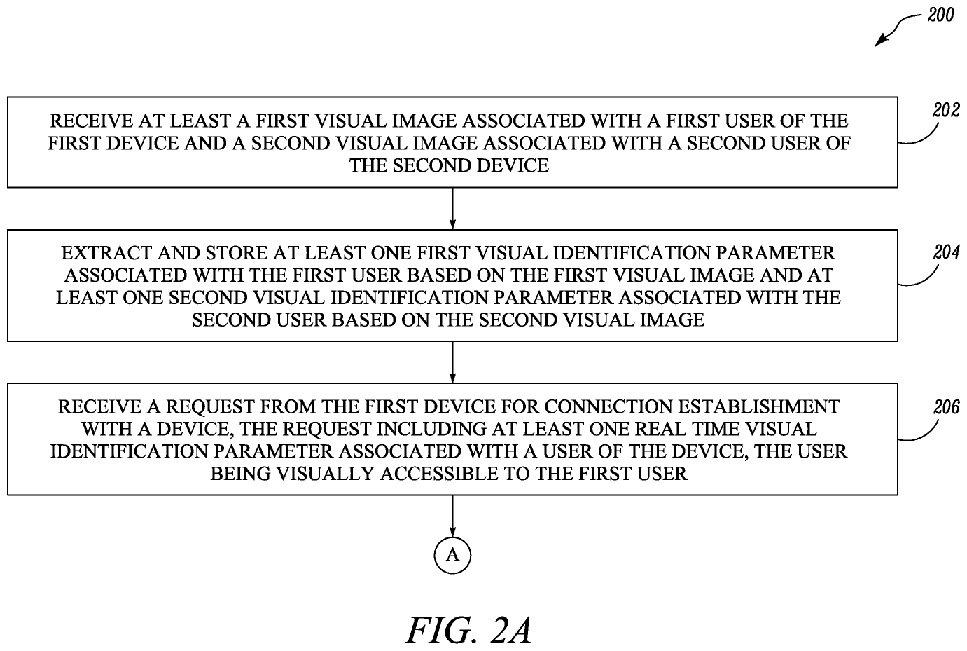

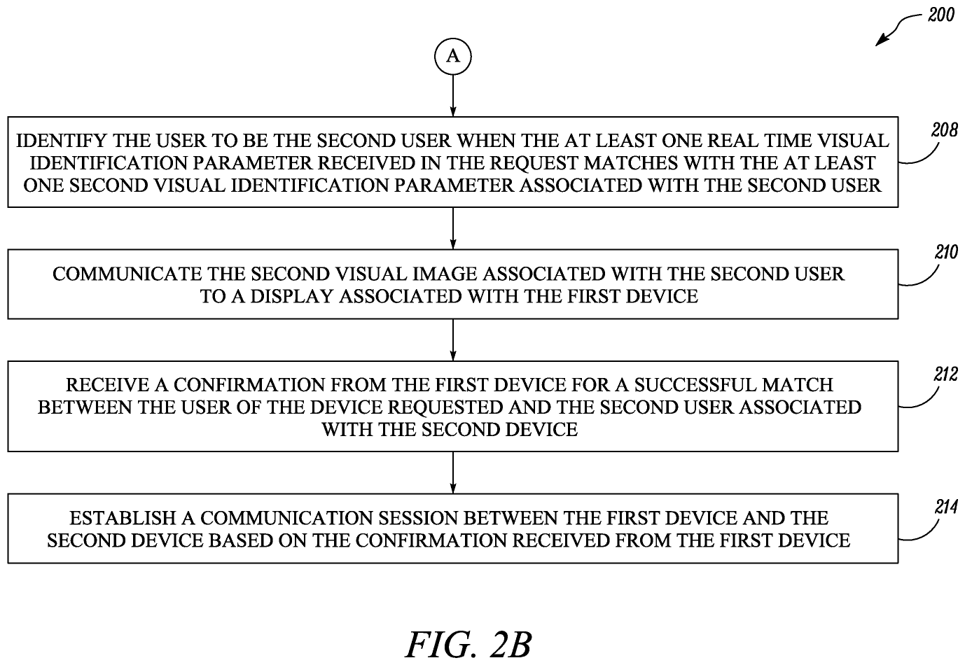

The present disclosure relates to a system and method for establishing a communication session between one or more devices. FIG. 1 illustrates a system 100 for establishing a communication session between a first device 102 and a second device 104, according to an embodiment of the present disclosure. FIG. 2 illustrates an exemplary method 200 performed by the system 100 for establishing a communication session between the first device 102 and a second device 104, according to an embodiment of the present disclosure.

The first device 102 and the second device 104 may be implemented on a mobile device, such as a cellphone, a tablet, a laptop or may be implemented on a desktop. Each of the first device 102 and the second device 104 include their respective Input/Output unit, such as touchscreen display 106 and 108, respectively. The first device 102 may be associated with and used by a first user 103 and the second device 104 may be associated with and used by a second user 105.

The first device 102 and the second device 104 communicate with the system 100 and with each other over a communication network (not shown). The communications links depicted in FIG. 1 may be through wired or wireless connections and may be part of the communication network, such as a local area network (LAN) and/or a combination of networks, such as LANs, WANs, MANs and/or the Internet. The communication network may be implemented using well known network protocols, such as, TCP (Transmission Control Protocol), UDP (User Datagram Protocol), XMPP (Extensible Messaging and Presence Protocol), BLUETOOTH®, WIFI, etc.

The system 100 depicted in FIG. 1 may be implemented in any suitable computing environment, such as, a desktop, a laptop computer, a computer server, or a mobile computing device, such as a mobile phone, a Personal Digital Assistant (PDA), or a smart phone. In addition, the system 100 may be combined into fewer systems than shown or may be divided into more systems than shown. In one embodiment of the present disclosure, the system 100 is implemented remotely from the first device 102 and the second device 104. In an alternative embodiment, the system 100 may be implemented within either or both of the first device 102 and the second device 104.

The system 100 includes an Input/Output (I/O) unit 110, a memory unit 112, a processor 114 and a communication unit 116. The memory unit 112 may be Random Access Memory (RAM) or Read Only Memory (ROM). The system 100 may further include a storage device, which may be a hard-disk drive or a removable storage drive, such as, a floppy-disk drive, optical-disk drive, and the like. The storage device may also be a means for loading computer programs or other instructions into the computer system. The processor 114 includes a microprocessor connected to a communication bus (not shown). The communication unit 116 facilitates the system 100 to connect to the first device 102 and the second device 104 over the network through the I/O unit 110, allowing the transfer as well as reception of data from these sources. The communication unit 116 may include a modem, an Ethernet card, or other similar devices, which enable the system 100 to connect to the network. The system 100 facilitates input from the first user 103 and the second user 105 through the Input/Output devices of the I/O unit 110 of the system 100.

Referring FIGS. 1 and 2, the system 100 is configured to perform a method 200 for establishing a communication session between the first device 102 and the second device 104. In an embodiment of the present disclosure, the processor 114 is configured to perform the steps of the method 200, as described in the following description. Although only two devices are shown and described in this description, it may be contemplated that the number of devices may vary and function in a similar manner, as described herein, without deviating from the scope of the claimed subject matter. The communication session may be established between the first device 102 and the second device 104 in an environment where there are many people gathered, such as in a conference, a college festival, in a train, etc. Any two or more devices in such an environment may connect with one another using the system 100 and the method 200 of the present disclosure.

At step 202, the processor 114 receives a first visual image associated with the first user 103 of the first device 102 and a second visual image associated with the second user 105 of the second device 104. For example, the first user 103 may have a profile picture captured using a camera device (not shown) associated with the first device 102. Similarly, the second user 105 may also have a respective profile picture captured using a camera device (not shown) associated with the second device 102. The processor 114 may receive these profile pictures, as the first and the second visual images, from the first device 102 and the second device 104 via the communication links and the communication unit 116. Other examples of the visual images may include, but not limited to, sketches, avatars, pictures of the immediate surroundings of the users, posts from the user, or any other object handled or held by the user, etc. In an embodiment of the present disclosure, the users may update their profile pictures and send the updated profile pictures to the processor 114 on a regular basis, such as every day. The processor 114 may store these received visual images from the first device 102 and the second device 104 in the memory 112 and the storage device associated with the system 100.

In a further embodiment of the present disclosure, the processor 114 may also assign or receive a unique identification number associated with each of the first device 102 and the second device 104. For example, the processor 114 may store the received visual images in accordance with and in association with the unique identifiers of the respective devices. In a further embodiment, the processor may also receive geographical location of each of the first device 102 and the second device 104 and store the same.

At step 204, the processor 114 extracts and stores at least one first visual identification parameter associated with the first user 103 based on the first visual image and at least one second visual identification parameter associated with the second user 105 based on the second visual image. In an embodiment of the present disclosure, the visual identification parameters include one or more of color of clothes of the user in the visual image, pattern of clothes of the user in the visual image, identifier of at least one object present within the visual image, or an identifier of a text present within the visual image, etc. The processor 114 may store these identified visual identifiers in association with the unique identifiers of the respective devices, from which their corresponding visual images are received.

At step 206, the processor 114 receives a request from the first device 102 for connection establishment with a device. For example, the request includes at least one real time visual identification parameter associated with a user of the device, who is visually accessible to the first user 103. For example, in a train, when the first user 103 sees another user within the train and that user has a device, then the first user 103 may request a connection establishment with the device of that user, through the system 100. The first user 103 may provide one or more visual identification parameters that are visible in real time associated with the user. For example, the first user 103 provides that the user is wearing a blue shirt with black pant. Now the blue shirt and the black pant are the real time visual identification parameters associated with the user.

The processor 114 may then look up the records stored in the system to extract all the visual images that have these visual identification parameters associated with them. In an embodiment, the processor 114 may only extract those users, who are in proximity of the first user 103. For example, based on the geographical location of the devices, the processor 114 may look up all the devices that have a distance from the first device 102 to be less than a threshold value. The threshold value may be decided according to the location of the first user 102. In examples, where the first device 102 is in a train, the threshold value may be different than the threshold value when the first device 102 is in a stadium. The threshold value may also be determined in real time.

Further, at step 208, processor 114 identifies the user to be the second user 105 when the at least one real time visual identification parameter received in the request matches with the at least one second visual identification parameter associated with the second user 105.

Once the user requested by the first user 103 through the first device 102 is identified to be the second user 105 using the second device 104 as stored in the system 100, then, at step 210 the processor 114 may communicate the second visual image associated with the second user 105 to the display 106 of the first device 102. The first user 103 of the first device 102 may then recognize and confirm that the second user 105 as identified and provided by the processor 114 is the same as the user visible to him in real time.

Subsequently, at step 212, the processor 114 receives a confirmation from the first device 102 for a successful match between the user of the device requested and the second user 105 associated with the second device 104. For example, the first user 103 may provide the successful confirmation by sending an acknowledgement via the touchscreen display 106 or other I/O device associated with the first device 102 to the I/O unit 110 of the system 100.

Once the successful confirmation is received from the first device 102, the processor 114, at step 214, then establishes a communication session between the first device 102 and the second device 104. The first device 102 can then communicate through the established communication session with the second device 104. In one example, the first device 102 can establish a one-way communication session with the second device 104, so as to send messages or feeds to the second device 104.

The processor 114 may further receive an acknowledgment from the second device 104 to establish a two-way communication session between the two devices. Therefore, the second device 104 can also send messages or feeds to the first device 102 to have a two-way communication. Alternatively, if the second device 104 does not send an acknowledgment of the communication session established by the first device 102, then the communication session may be terminated or blocked after a predetermined time period. For example, if for 1 hour, there is no acknowledgement received from the second device 104, then the system 100 may terminate the established communication session. It may be contemplated that the predefined time period is mentioned to be 1 hour in an exemplary embodiment and may be varied without deviating from the scope of the claimed subject matter.

The system 100 and the method 200 of the present disclosure, provide establishment of a communication session between the first device 102 and the second device 104 without requiring personal details of the respective users of these devices. Further, the visual image and visual identification parameter-based identification of users is simple and accurate way of identification of the users in real time and hence establish a more accurate communication session with the most relevant and accurate user.

I/we claim:

1. A system for establishing a communication session between a first device and a second device, the system comprising a processor configured to:
receive at least a first visual image associated with a first user of the first device and a second visual image associated with a second user of the second device;
extract and store at least one first visual identification parameter associated with the first user based on the first visual image and at least one second visual identification parameter associated with the second user based on the second visual image;
receive a request from the first device for connection establishment with a device, the request including at least one real time visual identification parameter associated with a user of the device, the user being visually accessible to the first user;
identify the user to be the second user when the at least one real time visual identification parameter received in the request matches with the at least one second visual identification parameter associated with the second user;
communicate the second visual image associated with the second user to a display associated with the first device;
receive a confirmation from the first device for a successful match between the user of the device requested and the second user associated with the second device; and
establish a communication session between the first device and the second device based on the confirmation received from the first device.

2. The system as claimed in claim 1, wherein the at least one visual identification parameter includes one or more of color of clothes of the user in the visual image, pattern of clothes of the user in the visual image, identifier of at least one object present within the visual image, or an identifier of a text present within the visual image.

3. The system as claimed in claim 1, wherein the processor is further configured to receive a unique identification number associated with the first device and the second device, the unique identification number being stored in association with the first visual image of the first user and the second visual image of the second user.

4. The system as claimed in claim 1, wherein the processor is configured to receive a geographical location coordinate of the first device and the second device, and wherein the second visual image of the second user is communicated to the first service when a distance between the geographic location of the first device and the geographic location of the second device is less than a predefined threshold value.

5. The system as claimed in claim 1, wherein the processor is remotely located from the first device and the second device.

6. The system as claimed in claim 1, wherein the processor is positioned within one or both of the first device and the second device.

7. A method for establishing a communication session between a first device and a second device, the method comprising:
receiving, by a processor, at least a first visual image associated with a first user of the first device and a second visual image associated with a second user of the second device;
extracting and storing, by the processor, at least one first visual identification parameter associated with the first user based on the first visual image and at least one second visual identification parameter associated with the second user based on the second visual image;
receiving, by the processor, a request from the first device for connection establishment with a device, the request including at least one real time visual identification parameter associated with a user of the device, the user being visually accessible to the first user;
identifying, by the processor, the user to be the second user when the at least one real time visual identification parameter received in the request matches with the at least one second visual identification parameter associated with the second user;
communicating, by the processor, the second visual image associated with the second user to a display associated with the first device;
receiving, by the processor, a confirmation from the first device for a successful match between the user of the device requested and the second user associated with the second device; and
establishing, by the processor, a communication session between the first device and the second device based on the confirmation received from the first device.

8. The method as claimed in claim 7, wherein the at least one visual identification parameter includes one or more of color of clothes of the user in the visual image, pattern of clothes of the user in the visual image, identifier of at least one object present within the visual image, or an identifier of a text present within the visual image.

9. The method as claimed in claim 7, wherein the processor is further configured to receive a unique identification number associated with the first device and the second device, the unique identification number being stored in association with the first visual image of the first user and the second visual image of the second user.

10. The method as claimed in claim 7, wherein the processor is configured to receive a geographical location coordinate of the first device and the second device, and wherein the second visual image of the second user is communicated to the first service when a distance between the geographic location of the first device and the geographic location of the second device is less than a predefined threshold value.
